(19) United States
(12) Patent Application Publication
(10) Pub. No.: US 2007/0260627 A1
(43) Pub. Date: Nov. 8, 2007

(54) Method and apparatus for selective content modification within a content complex

(75) Inventors: Steven F. Knittel, West Allenhurst, NJ (US); Madhav Moganti, Piscataway, NJ (US); Jie Zhou, Naperville, IL (US)

Correspondence Address: PATTERSON & SHERIDAN, LLP/;LUCENT TECHNOLOGIES, INC, 595 SHREWSBURY AVENUE, SHREWSBURY, NJ, 07702, US

(73) Assignee: Lucent Technologies Inc.

(21) Appl. No.: 11/417,560

(22) Filed: May 3, 2006

(51) Int. Cl. G06F 7/00

(52) U.S. Cl. 707/101

(57) ABSTRACT

The invention includes a method and apparatus for controlling content provided from a content originator to an end-user. A method includes receiving a content complex comprising a plurality of content originator content components conveying content originator content, identifying each of the content originator content components classified as a replaceable content component, analyzing the replaceable content components to recognize the content originator content conveyed by the replaceable content components, and modifying, according to the end-user profile and the content originator content conveyed by the replaceable content components, at least one of the replaceable content components using at least one service provider replacement content component adapted for conveying service provider replacement content. The service provider replacement content may include service provider revenue generation content such as service provider advertisements.

### FIELD OF THE INVENTION

The invention relates to the field of communication networks and, more specifically, to controlling content components within a content complex conveyed over communication networks.

### BACKGROUND OF THE INVENTION

As more end-users obtain network access and new services are introduced, end-user requested/interested content available from content owners continues to increase. The end-users access the network using a service provider network. The end-user obtains content either directly from content owners (e.g., Lucent Technologies, Disney Entertainment, and the like) or indirectly from content owners via content providers (e.g., Google; also known as content distributors). The content traverses the service provider network from the content owner or content provider to the end-user, however, the service provider network merely acts as a conduit through which content passes between the content owner and content provider and the end-user. In other words, service provider networks are essentially transparent to content owners and content providers, as well as to end-users.

In order to increase revenue generation, content owners/providers typically marry content owner/provider revenue generating content to the content owner content, such that both the content owner content and content owner/provider revenue generating content are provided to the end-user. Disadvantageously, however, since the service provider network merely operates as a conduit, service providers do not currently have control over content owner content or, more importantly, content owner/provider revenue generating content. As such, while service providers invest billions of dollars on infrastructure, service management, and providing various functions to end-users, content providers (and some content owners) receive all of the benefits of revenue generating content.

Furthermore, as the amount of available content increases, frivolous content continues to explode. In some countries, end-users pay for network service in terms of bandwidth (e.g., paying a fixed price for each megabyte of information provided to the end-user). As such, by marrying frivolous content with requested content, content providers are able to force frivolous content on the end-users, thereby causing significant increases in the cost of network service paid by the end-users.

### SUMMARY OF THE INVENTION

Various deficiencies in the prior art are overcome by a method and apparatus for controlling content provided from a content originator to an end-user. A method includes receiving a content complex comprising a plurality of content originator content components conveying content originator content, identifying each of the content originator content components classified as a replaceable content component, analyzing the replaceable content components to recognize the content originator content conveyed by the replaceable content components, and modifying, according to the end-user profile and the content originator content conveyed by the replaceable content components, at least one of the replaceable content components using at least one service provider replacement content component adapted for conveying service provider replacement content. The service provider replacement content may include service provider revenue generation content such as service provider advertisements.

In one embodiment, another method may include obtaining a plurality of end-user profiles associated with a respective plurality of end-users, processing an original version of the requested content to form thereby a plurality of modified versions of the requested content associated with respective end-users, wherein each modified version of the requested content is formed using at least one end-user profile characteristic associated with the end-user, and transmitting the modified versions of the requested content toward a plurality of end-user devices associated with the respective end-users. The modified versions of the requested content may be formed for providing various flavors of the same content to different users associated with a user group.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of a communication network;

FIG. 2 depicts a method according to one embodiment of the present invention;

FIG. 3 depicts a method according to one embodiment of the present invention;

FIG. 4 depicts a method according to one embodiment of the present invention;

FIG. 5 depicts a high-level block diagram of an architecture for modifying content originator replaceable content using service provider replacement content;

FIG. 6A depicts an exemplary multimedia content complex (webpage) before content modification using the present invention;

FIG. 6B depicts an exemplary multimedia content complex (webpage) after content modification using the present invention;

FIG. 7 depicts a high-level block diagram of a communication network for providing different versions of content to different end-user devices within a single location;

FIG. 8 depicts a method according to one embodiment of the invention; and

FIG. 9 depicts a high-level block diagram of a general-purpose computer suitable for use in performing the functions described herein.

To facilitate understanding, identical reference numerals have been used, where possible, to designate identical elements that are common to the figures.

### DETAILED DESCRIPTION OF THE INVENTION

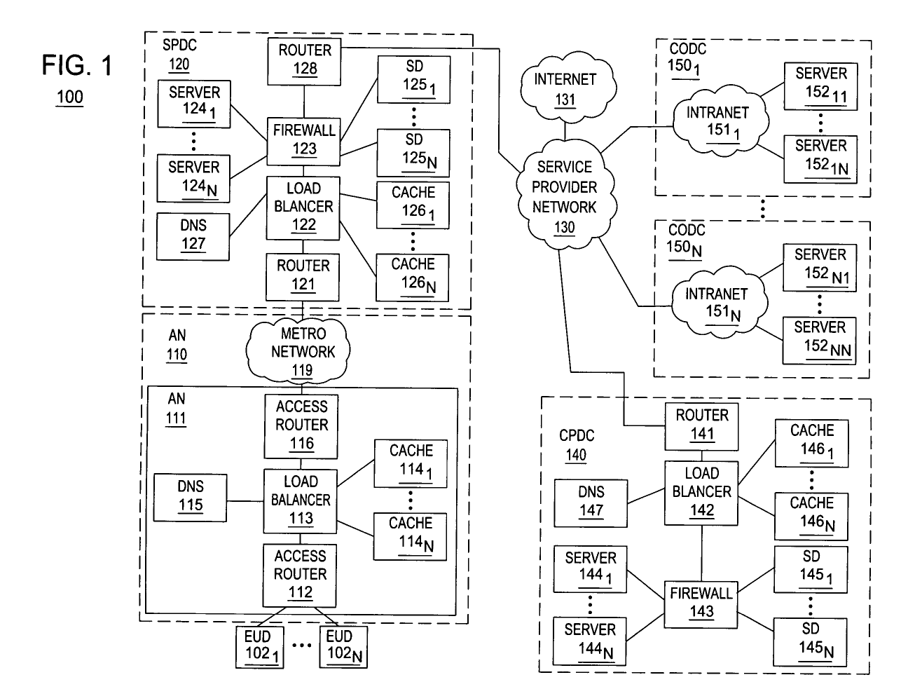

FIG. 1 depicts a high-level block diagram of a communication network. Specifically, communication network 100 includes a plurality of end-user devices (EUDs) 102₁-102_{N} (collectively, EUDs 102), an access network (AN) 110, a service provider data center (SPDC) 120, a service provider network (SPN) 130, a content provider data center (CPDC) 140, and a plurality of content owner data centers (CODCS) 150₁-150_{N} (collectively, CODCs 150). The EUDs 102 communicate with AN 110. The AN 110 communicates with network elements of SPDC 120. The network elements of SPDC 120, CPDC 130, and CODCs 150, respectively, communicate using SPN 130.

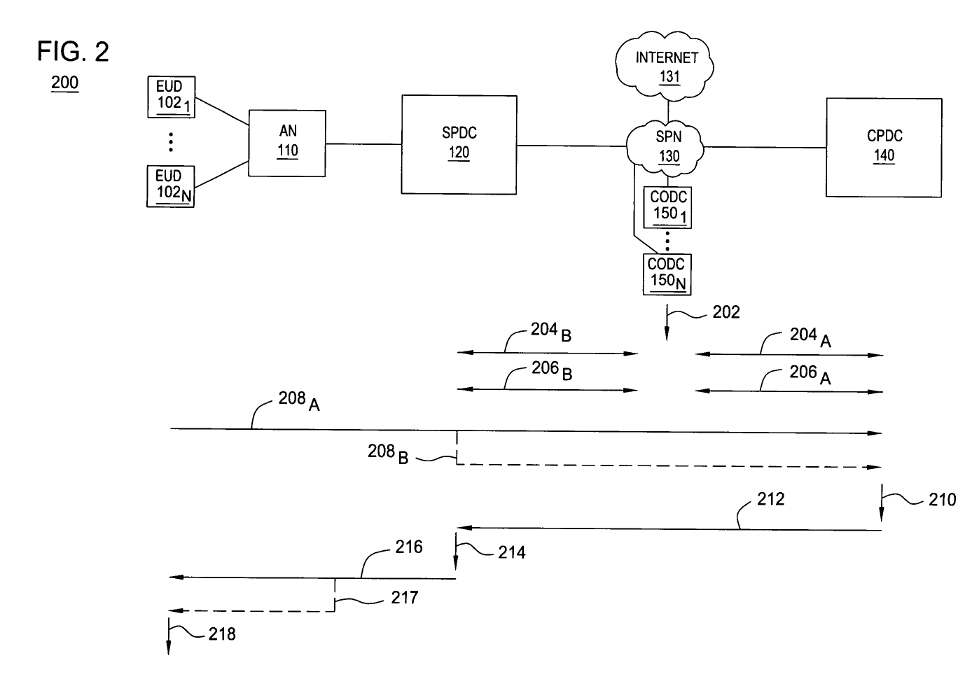

As depicted in FIG. 1, EUDs 102 include devices operable for initiating requests for content, as well as receiving content (e.g., text, data, audio, video, multimedia, and the like, as well as various combinations thereof) and presenting the received content to at least one associated end-user. The EUDs 102 include devices operable for processing one or more content complexes to present content conveyed by the content complex(es) to one or more associated end-users. The EUDs 102 may include any type of end-user devices (e.g., Personal Data Assistants (PDAs), desktop computers, laptop computers, VoIP phones, wireless phones, and the like, as well as various combinations thereof) operable for accessing any access network In one embodiment, EUDs 102 may be adapted for providing at least a portion of the functions depicted and described herein with respect to FIG. 2-FIG. 5.

As depicted in FIG. 1, AN 110 may include any access network (e.g., a wireline access network, a wireless access network, a converged wireline and wireless network, and the like, as well as various combinations thereof). For example, EUDs 102 may access wireless local area networks (WLNs), cable networks, digital subscriber line (DSL) networks, satellite networks, fiber-to-the-home (FTTH) networks, and the like, as well as various combinations thereof. Accordingly, although depicted and described as comprising specific network elements, depending on the technologies of the access network, AN 110 may include various other network elements configured in various other network architectures.

As depicted in FIG. 1, AN 110 includes an access node (AN) 111 and a metro network (MN) 119. The AN 111 includes an access router (AR) 112, a load-balancer (LB) 113, a plurality of caches 114₁-114_{N} (collectively, caches 114), a domain name server (DNS) 115 (or, alternatively, a naming server), and an access router (AR) 116. The LB 113 provides load balancing of traffic associated with the various components of AN 111. The caches 114 store recently accessed content, service provider content, and the like, as well as various combinations thereof. In one embodiment, various combinations of components of AN 110 interoperate in a manner for providing at least a portion of the functions depicted and described herein with respect to FIG. 2-FIG. 5.

As depicted in FIG. 1, SPDC 120 includes a router 121, a load-balancer (LB) 122, a firewall (FW) 123, a plurality of servers 124₁-124_{N} (collectively, servers 124), a plurality of storage devices (SDs) 125₁-125_{N} (collectively, SDs 125), a plurality of caches 126₁-126_{N} (collectively, caches 126), a domain name server (DNS) 127 (or, alternatively, a naming server), and a router 128. The LB 122 provides load balancing of traffic associated with the various components of SPDC 120. The FW 123 provides security functions for information passing through SPDC 120. In one embodiment, at least a portion of the servers 124 may include application servers. The servers 124 retrieve stored content from SDs 125. In one embodiment, at least a portion of the servers 124 may be adapted for modifying content originator content (i.e., content owner content, content provider content, and the like, as well as various combinations thereof) using service provider content.

In one embodiment, at least a portion of the SDs 125 store content controlled by the service provider (denoted as service provider content). In general, service provider content includes any content controlled by a service provider. In one embodiment, service provider content includes service provider replacement content (SP-RC). In one embodiment, at least a portion of the SP-RC includes service provider revenue generating content (SP-RGC). For example, SP-RGC may include advertisements (e.g., banners adapted for being displayed on webpages) provided to the service provider by content owners (e.g., Lucent Technologies provides an advertisement banner to AT&T (for use in replacing advertisement banners initially inserted by a content provider such as Google) for inclusion in search result pages related to telecommunications). In one embodiment, SP-RC may be stored as individual service provider replacement content objects. In one embodiment, at least a portion of SP-RC is stored as indexed SP-RC. In one embodiment, various combinations of components of SPDC 320 interoperate in a manner for providing at least a portion of the functions depicted and described herein with respect to FIG. 2-FIG. 5.

As depicted in FIG. 1, SPN 130 enables communication between EUDs 102 and CPDC 140 and CODCs 150, as well as between each of the data centers (i.e., between SPDC 120, CPDC 140 and CODCs 150). Although not depicted, SPN 130 may include routers, switches, and various other network elements adapted for supporting communication between EUDs 102, SPDC 120, CPDC 140, and CODCs 150. Although omitted for purposes of clarity, in one embodiment, SPN 130 supports communications from various other networks, network elements, data centers, and the like, as well as various combinations thereof. As depicted in FIG. 1, SPN 130 communicates with Internet 131.

As depicted in FIG. 1, CPDC 140 includes a router 141, a load-balancer (LB) 142, a firewall (FW) 143, a plurality of servers 144₁-144_{N} (collectively, servers 144), a plurality of storage devices (SDs) 145₁-145_{N} (collectively, SDs 145), a plurality of caches 146₁-146_{N} (collectively, caches 146), and a domain name server (DNS) 147 (or, alternatively, a naming server). The LB 142 provides load balancing of traffic associated with the various components of CPDC 140. The FW 143 provides security functions for information passing through CPDC 140. In one embodiment, at least a portion of the servers 144 may include application servers. The servers 144 retrieve stored content from SDs 145. In one embodiment, at least a portion of the servers 144 may be adapted for modifying content owner content using other content (e.g., content provider content, service provider content, and the like).

In one embodiment, at least a portion of the SDs 145 store content controlled by the content provider (denoted as content provider content). In general, content provider content includes any content controlled by a content provider. In one embodiment, content provider content includes content provider replaceable content (CP-RC). In one embodiment, at least a portion of the CP-RC includes content provider revenue generating content (CP-RGC). For example, CP-RGC may include advertisements (e.g., banners adapted for being displayed on webpages) provided to the content provider by content owners (e.g., Lucent Technologies provides an advertisement banner to Google for inclusion in search result pages related to telecommunications). In one embodiment, CP-RC may be stored as individual content provider replaceable content objects. In one embodiment, at least a portion of CP-RC is stored as indexed CP-RC. In one embodiment, various combinations of components of CPDC 140 interoperate in a manner for providing at least a portion of the functions depicted and described herein with respect to FIG. 2-FIG. 5.

As depicted in FIG. 1, CODCs 150₁-150_{N} include a plurality of intranets, enterprise portals, and/or secure web servers 351₁-351_{N} (collectively, intranets 351), respectively, which may include respective pluralities of routers. The CODCs 150₁-150_{N} include respective pluralities of servers 152₁₁-152_{1N} (collectively, servers 152₁) through 152_{N1}-152_{NN} (collectively, servers 152_{N}). The servers 152₁-152_{N} may be collectively referred to as servers 152. The servers 152 may be referred to as content owner servers 152. The servers 152₁-152_{N} store content owned by content owners which operate CODCs 150₁-150_{N}, respectively. The content owned by content owners may be referred to as content owner content. The content owner content may be requested by end-users, pushed to end-users, and the like, as well as various combinations thereof.

FIG. 2 depicts a method according to one embodiment of the present invention. As depicted in FIG. 2, method 200 is depicted and described with respect to communication network 100 of FIG. 1. Specifically, method 200 is depicted and described with respect to EUDs 102, AN 110, SPDC 120, SPN 130, CPDC 140, and CODCs 150 of communication network 100. Although specific components of AN 110, SPDC 120, CPDC 140, and CODCs 150 have been omitted from FIG. 2 for purposes of clarity, method 200 is described herein with respect to the various components of AN 110, SPDC 120, CPDC 140, and CODCs 150.

At step 202, content owners generate, structure, and store content owner content. The content owners own content available for distribution using some information distribution medium. For example, content owners may include companies (e.g., Lucent Technologies, Best Buy, Circuit City, and the like) offering product and service information, online product and service ordering capabilities, and the like, as well as various combinations thereof. For example, content owners may include news providers (e.g., The New York Times) offering online news stories. For example, content owners may include information providers (e.g., Wikipedia, online encyclopedias, and the like) offering various types of online information. For example, content owners may be individuals maintaining personal webpages. Although described with respect to specific examples, content owners may include any company, organization, agency, person, and the like, as well as various combinations thereof.

The content owner content may be generated using any means of generating content. For example, generation of content owner content may include generating sales brochures, writing news stories, recording audio and video clips, enabling users to post online comments, and the like, as well as various combinations thereof. The generated content owner content may be structured using any means of structuring content. The content owner content may be structured to form one or more content complexes, where a content complex comprises a structure adapted for conveying content (e.g., webpage, video frame, and the like, as well as various combinations thereof). In one embodiment, structuring of content owner content may include formatting content components of which a content complex is composed (e.g., formatting webpage objects to include generated content owner webpage content, processing television signals to form video frames adapted for conveying television content, and the like, as well as various combinations thereof).

The generated and structured content owner content is stored by the content owner for distribution to end-users. The generated and structured content owner content may be stored on servers 152₁-152_{N} of CODCs 150₁-150_{N}, respectively, as well as various storage devices (omitted for purposes of clarity) in communication with servers 152₁-152_{N} of CODCs 150₁-150_{N}, respectively. In one embodiment, content owners may distribute information using any information distribution medium (e.g., online webpages, audio streams, video streams, and the like, television signals, and the like, as well as various combinations thereof) such that content owner content may include any content type accessible using a network connection (e.g., text, data, audio, video, multimedia, and the like, as well as various combinations thereof).

In one embodiment, generation, structuring, and storage of content owner content depends on the content complex type (e.g., webpages, video frames, and the like, as well as various combinations thereof). In one embodiment, generation, structuring, and storage of content owner content depends on content type (e.g., text, data, audio, video, multimedia, and the like, as well as various combinations thereof) included within the content complex. As described herein, a content complex formed by a content owner may include non-replaceable content components and replaceable content components.

At step 204_{A}, content providers associate content provider revenue generating content (CP-RGC) with the content owner content. In one embodiment, the content owners may add the CP-RGC to the content owner content (e.g., adding content provider content components to a content complex generated and structured by the content owner). In one embodiment, association of CP-RGC to content owner content may be performed according to the content owner content. In one such embodiment, association of CP-RGC to content owner content may be performed by parsing the content owner content for keywords, and selecting the CP-RGC that is associated with the content owner content according to the keywords. For example, for content owner content including news stories on advances in telecommunications, the content provider may associate CP-RGC of telecommunications service providers with the content owner content on advances in telecommunications.

At step 206_{A}, content providers index content. In one embodiment, content providers index content owner content stored on servers 152₁-152_{N} of CODCs 150₁-150_{N}, respectively. In one embodiment, content providers index CP-RGC stored on servers 144, SDs 145 and caches 146. The indexes generated by the content provider may be stored on servers 144, SDs 145, and the like, as well as various combinations thereof. The indexes may be used by the content provider to provide improved responses to end-users (e.g., to search for requested content owner content in response to end-user content requests, to search for requested content owner content in response to network initiated content pushes, to search for CP-RGC associated with requested/pushed content owner content, and the like, as well as various combinations thereof).

At step 204_{B}, service providers associate service provider revenue generating content (SP-RGC) with the content owner content. The SP-RGC may be stored on servers 124, SDs 125 and caches 126. In one embodiment, the content owners may add the SP-RGC to the content owner content (e.g., adding service provider content components to a content complex generated and structured by the content owner). In one embodiment, association of SP-RGC to content owner content may be performed according to the content owner content. In one such embodiment, association of SP-RGC to content owner content may be performed by parsing the content owner content for keywords, and selecting the SP-RGC that is associated with the content owner content according to the keywords. For example, for content owner content including news stories on advances in telecommunications, the service provider may associate SP-RGC of telecommunications service providers with the content owner content on advances in telecommunications.

At step 206_{B}, service providers index content. In one embodiment, service providers index content owner content stored on servers 152₁-152_{N} of CODCs 150₁-150_{N}, respectively. In one embodiment, service providers index SP-RGC stored on servers 124, SDs 125 and caches 126. The indexes generated by the service provider may be stored on servers 124, SDs 125, and the like, as well as various combinations thereof. The indexes may be used by the service provider to provide improved responses to end-users (e.g., to search for requested content owner content in response to end-user content requests, to search for requested content owner content in response to network initiated content pushes, to search for SP-RGC associated with requested/pushed content owner content, and the like, as well as various combinations thereof).

Although primarily described with respect to generation of content indexes, in one embodiment, searching for content by searching content indexes may be performed using one or more end-user characteristics of an end-user profile associated with an end-user for which content is intended. Although the indexing mechanisms described herein with respect to content providers and service providers are similar, those skilled in the art will appreciate that, based on the underlying content technologies (e.g., for structuring content, storing content, searching content, and the like, as well as various combinations thereof), content indexing mechanisms used by content providers and service providers may be different. In one embodiment, the indexing mechanisms may include multimedia indexing algorithms covering text, images, audio, video, and the like, as well as various combinations thereof.

Although depicted and described herein as being performed in parallel, since available content owner content is continuously changing, and CP-RGC and SP-RGC is continuously changing, steps 204_{A} and 204_{B} are continuously performed by content provider and service providers, respectively. Similarly, although depicted and described herein as being performed in parallel, since available content owner content is continuously changing, and CP-RGC and SP-RGC is continuously changing, steps 206_{A} and 206_{B} are continuously performed by content provider and service providers, respectively. Moreover, although depicted and described herein as being performed in series, steps 204_{A} and 206_{A} associated with content providers and steps 204_{B} and 206_{B} associated with service providers may be continuously performed due to the continuous changes in available content owner content, as well as CP-RGC and SP-RGC, respectively.

At step 208_{A}, an end-user initiates a request for content from one of the EUDs 102. As depicted in FIG. 2, the request for content is initiated to the content provider. For example, the end-user may type one or more keywords (e.g., minivans) in the Search field of a content provider webpage (e.g., in the Search field of the Google homepage, i.e., “www.google.com”). The request for content is generated by the associated EUD 102 and traverses AN 110, SPDC 120, and SPN 130. The request for content is received and processed by components of CPDC 140. As depicted by step 208_{B}, in one embodiment, the request for content may, optionally, be proxied by one of the components of SPDC 120 (e.g., by router 121). In this embodiment, the component of SPDC 120 which proxies the request for content forwards the request for content to CPDC 140 via SPN 130.

Although described herein with respect to a request for content initiated by an end-user to a content provider, in one embodiment, a request for content may be initiated by an end-user directly to one of the content owners (e.g., the user types “www.lucent.com” in the Internet browser Address field and presses the Enter key). Although described herein with respect to a request for content initiated by an end-user to a content provider, in one embodiment, a request to push content to one or more end-users may be initiated by a network component (e.g., an end-user schedules a recurring daily feed of video clips configured to begin at a specific time each day). The present invention is not intended to be limited by the source of the content request (e.g., end-user or network), the source of the requested content (e.g., content provider or content owner), and the like.

At step 210, the content provider searches for the requested content. In one embodiment, the content provider searches for matching content which most closely matches the received request for content. In one embodiment, the content provider searches for the requested content by searching stored indexes for matching content (e.g., one of the servers 144 may search SDs 145 for indexes identifying matching content). In one embodiment, the content provider searches the indexes using one or more keywords received as part of the request for content. The content provider generates content request results. For example, if the request for content is a request using the keyword “minivans” the content request results may include a list of links to various webpages (e.g., a link to homepages of car manufacturers, links to news articles which reference minivans, links to automobile expert analysis pages, and the like).

The content provider matches CP-RC, which may include CP-RGC, to the content request results. In one embodiment, the content provider matches CP-RC to the content request results using at least one of information from the request for content received from the EUD, information from the content request results, information from an end-user profile, and the like, as well as various combinations thereof. The content provider structures the content request results and the CP-RC to form structured content (denoted herein as an original structured content complex). For example, the structured content may be a structured webpage including the links to webpages (returned as content request results) and advertisements (i.e., CP-RGC) positioned around the links to the webpages. In one embodiment, the matching of CP-RC to content request results may be performed by one of the servers 143.

In one embodiment, in which the content provider maintains an end-user profile associated with the end-user from which the request for content is received, the end-user profile may be updated in response to a request for content. In one embodiment, the end-user profile may be updated based on the request for content (e.g., using the keywords entered by the end-user during the request for content). In one embodiment, the content provider may store an association of the CP-RC with the end-user profile. For example, in one embodiment, the content provider may store a list of one or more advertisements targeted to that end-user as a portion of the associated end-user profile.

At step 212, the content provider transmits a response including the original structured content (i.e., original content complex) toward the EUD 102 from which the request for content originated. The response traverses SPN 130. The response may be transmitted using any communication networks, protocols, and the like operable for conveying structured content. In one embodiment, the response is trapped within SPDC 120 before reaching the EUD 102 from which the request for content originated. In one embodiment, the response is trapped within AN 110 (specifically, by AN 111) before reaching the EUD 102 from which the request for content originated. As depicted and described herein, the response is trapped by the service provider (illustratively, by SPDC 120; specifically, by one of the servers 123 of SPDC 120).

At step 214, the service provider intercepts the response including the original content complex. The service provider modifies the original structured content received in the intercepted response to form modified structured content (i.e., a modified content complex). The service provider identifies content originator non-replaceable content (e.g., content owner or content provider non-replaceable content). In one embodiment, the content provider identifies content originator non-replaceable content components within the original content complex. The service provider identifies content originator replaceable content (e.g., content owner or content provider replaceable content). In one embodiment, the content provider identifies content originator replaceable content components within the original content complex.

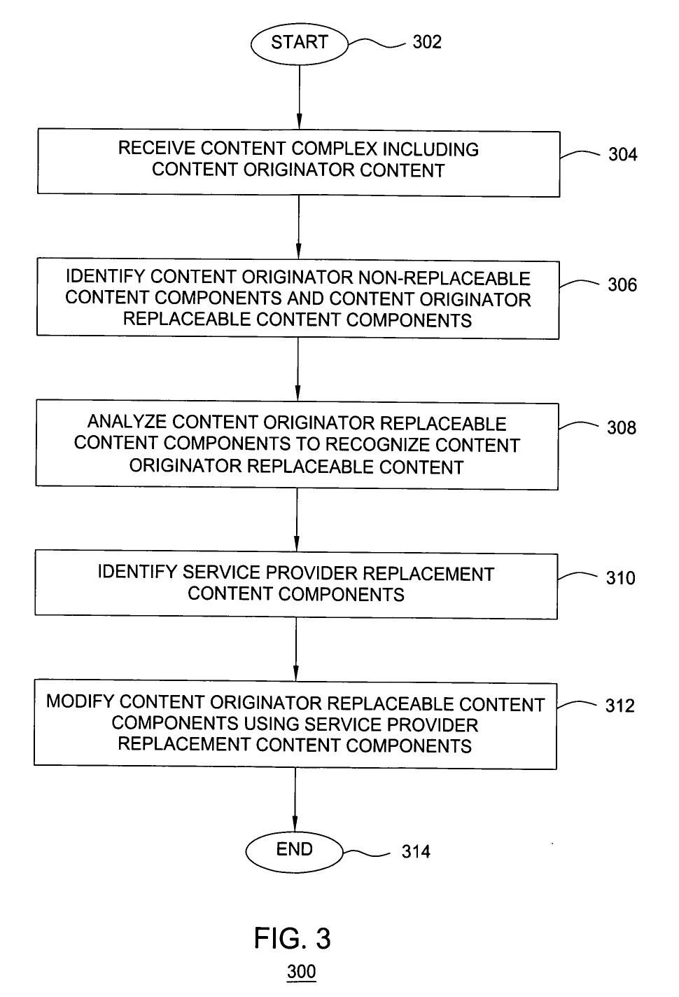

The service provider identifies SP-RC. In one embodiment, the service provider identifies SP-RC as one or more service provider replacement content components (e.g., one or more components of a webpage, one or more components of a video frame, and the like). In one embodiment, the service provider identifies SP-RC using an end-user profile associated with the end-user. The service provider modifies at least a portion of the content originator replaceable content using the SP-RC, which may include SP-RGC, white-space, and the like. The modification of content originator replaceable content using SP-RC may include removing the content originator replaceable content and inserting SP-RC, masking the content originator replaceable content with SP-RC, and the like, as well as various combinations thereof. The processing of original structured content (e.g., an original content complex) to form modified structured content (e.g., a modified content complex) may be better understood with respect to FIG. 3-FIG. 6.

The service provider structures the unmodified portion of the original content (i.e., content originator non-replaceable content and, if only a portion of the content originator replaceable content is modified using service provider replacement content, at least a portion of the content originator replaceable content) and the service provider replacement content to form modified structured content. For example, the modified structured content may be a structured webpage including links to webpages (returned as content request results included in the original structured content) and advertisements (i.e., SP-RGC) positioned around the links to the webpages (i.e., replacing or overlaying CP-RGC included in the original structured content). In one embodiment, at least a portion of the content modification processing may be performed by one or more of the servers 123.

In one embodiment, in which the service provider maintains an end-user profile associated with the end-user from which the request for content is received, the end-user profile may be updated in response to a request for content. In one embodiment, the end-user profile may be updated based on the request for content (e.g., using the keywords entered by the end-user during the request for content). In one embodiment, the service provider may store the association of the SP-RC with the end-user profile. For example, in one embodiment, the service provider may store a list of one or more advertisements targeted to that end-user as a portion of the associated end-user profile.

In one embodiment, an end-user profile maintained by the service provider (illustratively, stored in SDs 125) may include various parameters adapted for use by the service provider for controlling modification of content originator replaceable content using service provider replacement content. In one embodiment, at least a portion of the parameters of an end-user profile may be updated by the service provider according to requests for content received from the end-user device associated with that end-user. In one embodiment, at least a portion of the parameters of an end-user profile may be updated by the end-user (e.g., by logging into the end-user profile maintained by the service provider).

In one embodiment, for example, an end-user profile may include a modification permission parameter adapted to provide an indication as to which entities (e.g., which service providers, content providers, and the like) have the permission of that end-user to modify replaceable content with replacement content. In one embodiment, for example, an end-user profile may include one or more content preference parameters adapted to provide an indication as to the category of replacement content preferred by that end-user. For example, an end-user with a strong interest in football may configure an associated end-user profile to include a content preference value of “football” such that replaceable content is always replaced with football-related replacement content.

In one embodiment, for example, an end-user profile may include a replacement format indicator indicative of the manner by which replaceable content (the content complex) is modified using replacement content (e.g., replacement content replaces replaceable content, replacement content masks (e.g., overlays) replaceable content in a manner for enabling the end-user to request the masked replaceable content, and the like, as well as various combinations thereof). In one such embodiment, the replacement format indicator may be configurable such that different replacement format indicators may be set for different content types (e.g., audio, video, and the like), different content categories (e.g., football, racecars, financial information, and the like), and the like, as well as various combinations thereof.

At step 216, the service provider transmits a response including the modified structured content toward the EUD 102 from which the request for content originated. In one embodiment, the response from the service provider (including the modified content complex) is transmitted from SPDC 120 to the EUD 102 without additional modification of the modified structured content (e.g., by AN 111 of AN 110). In one optional embodiment (denoted as step 217), the response from the service provider (including the modified structured content) is trapped by an access element disposed between the service provider and the end-user device (illustratively, AN 111). In one such embodiment, at least a portion of the modified structured content received by AN 111 may be further modified by AN 111. In this embodiment, in which additional processing is performed on the modified structured content, the modified structured content is transmitted from AN 111 to the EUD 102.

In one embodiment, modification of the modified structured content by AN 111 may be performed in a manner similar to the modification of the original structured content performed by one or more of the components of SPDC 120. In one embodiment, a portion of the content originator replaceable content which was not modified during content modification processing within SPDC 120 may be modified by AN 111. In one embodiment, at least a portion of the SP-RC which was used to modify content originator replaceable content during content modification processing within SPDC 120 may be modified by AN 111. In one embodiment, for example, content (e.g., SP-RGC) available from caches 114 may be used to modify at least a portion of the content received by AN 111 as modified structured content.

In one embodiment, one or more communication protocols along end-to-end communication paths between content originators (i.e., content owners or content providers) and end-user devices may be enhanced to provide more efficient transport of content from content owners, content providers, and service providers to the end-user devices. In one embodiment, enhancement of communication protocols may depend on content type of content included within the original structured content and the modified structured content. For example, various communication protocols may utilize HTTP content optimization (e.g., comment removal, syntax abbreviation, and the like), HTTP header compression (e.g., uplink, downlink, and the like), content-aware compression (e.g., e-mail attachment compression), transcoding on wireless access, and the like, as well as various combinations thereof.

At step 218, the response is received by the one of the EUDs 102 associated with the end-user which initiated the request for content. The EUD 102 processes the response in order to present the modified content complex to the end-user using at least one presentation interface associated with EUD 102. Although not depicted, the end-user may select items from the presented content complex using an end-user interface of EUD 102, thereby resulting in one or more additional requests for content initiated from EUD 102 to at least one of a content provider, a content owner, and the like, as well as various combinations thereof.

Although described herein as being performed by content owners, content providers, and service providers, such functions performed content owners, content providers, and service providers are performed by various combinations of respective network components controlled by the content owners, content providers, and service providers. Furthermore, although primarily depicted and described herein as being performed by specific network components, or combinations of network components, various functions of the present invention may be performed by various other network components, various other combinations of network components, and the like, as well as various combinations thereof.

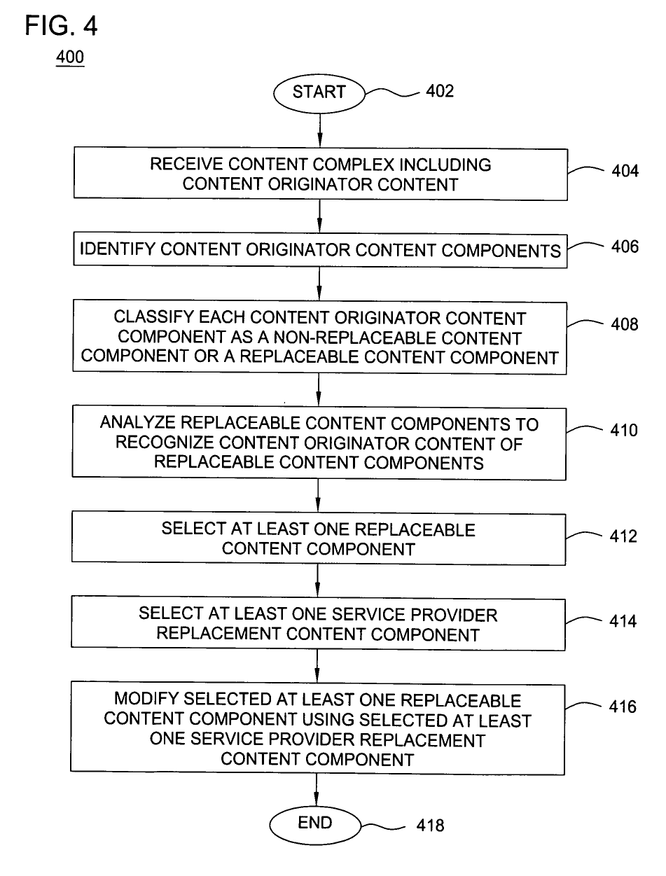

FIG. 3 depicts a method according to one embodiment of the present invention. Specifically, method 300 of FIG. 3 depicts a method for modifying content originator replaceable content using service provider replacement content. Although depicted as being performed serially, those skilled in the art will appreciate that at least a portion of the steps of method 300 may be performed contemporaneously, or in a different order than presented in FIG. 3. The method 300 may be better understood with respect to FIG. 4. The method 300 begins at step 302 and proceeds to step 304.

At step 304, a content complex including content originator content is received. At step 306, content originator non-replaceable content components and content originator replaceable content components of which the content complex is composed are identified. At step 308, content originator replaceable content components are analyzed to recognize the content originator replaceable content. At step 310, service provider replacement content components are identified. At step 312, at least a portion of the content originator replaceable content components are modified using the service provider replacement content components. At step 314, method 300 ends.

In one embodiment, within the context of a webpage, content originator content components and service provider content objects may include text, hyperlinks, images, advertisements, audio content, video content, pop-up windows, and the like, as well as various combinations thereof. In one embodiment, classification, analysis, recognition, and processing of content originator content components (and associated content originator content) and service provider content components (and associated service provider content) may be performed by parsing the content code (e.g., Hypertext Markup Language (HTML), Extensible HTML (XHTML), and the like), content representations, content formatting and structuring information (e.g., denoting headings, paragraphs, font sizes, font colors, hyperlinks, and the like, as well as various combinations thereof), and the like, as well as various combinations thereof.

Although primarily described with respect to parsing and processing content objects used to convey and structure webpage content, depending on the content types of the content originator content and service provider content, various other forms of content parsing and processing may be used for identification, categorization, classification, analysis, recognition, and processing of content originator content components (and associated content originator content) and service provider content components (and associated service provider content). For example, for television video content, each frame of the video stream conveying the television content may be processed as an individual content complex in order to identify non-replaceable and replaceable content components and recognize the content conveyed by the content components for modifying at least a portion of the replaceable content components using service provider replacement content (e.g., for strategic product placements such as replacing a can of Pepsi in a scene of a movie with a can of Coke).

FIG. 4 depicts a method according to one embodiment of the present invention. Specifically, method 400 of FIG. 4 depicts a method for modifying content originator replaceable content using service provider replacement content. Although described with respect to a specific content complex and content types (a structured webpage including webpage components), those skilled in the art will appreciate that method 400 may be used to modify various other content complex and content types. Although depicted as being performed serially, those skilled in the art will appreciate that at least a portion of the steps of method 400 may be performed contemporaneously, or in a different order than presented in FIG. 4. The method 400 begins at step 402 and proceeds to step 404.

At step 404, a content complex including content originator content is received. At step 406, content originator content components are identified. In one embodiment, content originator content components may be identified by parsing the content complex. In one embodiment, for example, content originator content components of a webpage may be identified by parsing the code (e.g., HTML, XML, and the like) of which the webpage is composed in order to identify tags which identify content originator content components. In another embodiment, for example, content originator content components of a video frame may be identified by parsing the image conveyed by the video frame. Although described with respect to specific processing performed for specific content complex types, various other processing may be performed to identify content originator content components.

At step 408, each identified content originator content component is classified as one of a non-replaceable content component or a replaceable content component. In one embodiment, classifying a content originator content component may include determining a content component type associated with each of the identified content originator content components, and classifying the content originator content components according to the content component types of the content originator content components. The classification of content originator content components as non-replaceable or replaceable may be performed using at least one of a plurality of classification factors (e.g., the location of the content originator content component within the content complex, the contents of the content originator content component (e.g., parsing an advertisement in order to determine the product advertised), and the like, as well as various combinations thereof).

In one embodiment, the content component type associated with a content originator content component may be identified by analyzing the placement of the content originator content component within the content complex. In one embodiment, for example, content originator content components of a webpage located within the middle of the webpage may be classified as non-replaceable content components while content originator content components of a webpage located at the edges of the webpage may be classified as replaceable content components. Although described herein with respect to specific examples, various other techniques may be used for classifying a content originator content component according to the placement of the content originator content component within the content complex.

In one embodiment, the content component type associated with each content originator content component may be identified by analyzing each content originator content component to recognize the content originator content conveyed by each content originator content component. In one embodiment, for example, content originator content components of a webpage may be classified by parsing the code of which the content originator content component is composed in order to identify tags, keywords, and the like by which the content originator content component may be classified. For example, a content originator content component including tags which identify a photograph (e.g., for a news story) may be classified as a non-replaceable content component while a content originator content component including keywords such as “advertisement”, “sponsored links”, and the like may be classified as a replaceable content component.

At step 410, each replaceable content component is analyzed in order to recognize content originator content of each of the replaceable content components. In one embodiment, a replaceable content component may be analyzed in order to recognize the content originator content by parsing the replaceable content component to identify at least one content characteristic of the content originator content conveyed by the replaceable content component and recognizing the content originator content conveyed by the replaceable content component according to the at least one content characteristic. The processing of a replaceable content component to identify conveyed content originator content may vary according to content complex type (e.g., webpage, video frame, and the like), content type (text, audio, video, and the like), and the like, as well as various combinations thereof.

In one embodiment, for example, for a webpage content complex, content originator content conveyed by a content originator content component of the webpage may be recognized by parsing the code of which the content originator content component is composed (e.g., to identify code tags, keywords, and the like by which the content originator content may be recognized). For example, a content originator content component including keywords such as “advertisement” or “sponsored links” may be processed for identifying additional keywords by which the content of the content originator content component may be recognized (e.g., a keyword of “Audi” may be used to identify the replaceable content component as a car advertisement).

In one embodiment, for example, for a video frame content complex, content originator content conveyed by a content originator content component of the video frame may be recognized by performing image processing on the portion of the image conveyed by the content originator content component. For example, a content originator content component including a beverage container may be recognized by analyzing the content originator content component to recognize the shape of the beverage container, recognize one or more words on the beverage container (e.g., Coke, Pepsi, and the like), and the like, as well as various combinations thereof.

At step 412, at least one replaceable content component is selected. In one embodiment, the at least one replaceable content component is selected to be modified using at least one service provider replacement component. In one embodiment, selection of the at least one replaceable content component is performed using the recognized content originator content of each of the replaceable content components. In one such embodiment, at least one characteristic of the recognized content originator content may be identified for use in determining whether to select that replaceable content component for modification. In one embodiment, selection of the at least one replaceable content component is performed using an end-user profile associated with the end-user for which the content complex including the replaceable content component is intended.

In one embodiment, the determination as to whether a replaceable content component is selected for modification is performed using the recognized content originator content of the replaceable content component and the end-user profile associated with the end-user for which the content complex including the replaceable content component is intended. In one embodiment, for example, recognized content originator content may be evaluated in a manner enabling a comparison of at least one characteristic of the recognized content originator content with the end-user profile. In one such embodiment, for example, recognized content originator content may be indexed in a manner enabling a comparison of at least one characteristic of the recognized content originator content with the end-user profile.

In one embodiment, each replaceable content component is evaluated individually for determining whether that replaceable content component is selected for modification. In one such embodiment, the comparison of the recognized content originator content with the end-user profile may result in a relevancy score indicative of relevancy of the recognized content originator content to the end-user (e.g., the level of interest the end-user may have in receiving the recognized content originator content). In this embodiment, selection of the at least one replaceable content component is performed according to the relevancy score of the replaceable content component (e.g., the replaceable content component is not selected if the relevancy score is below a threshold and the replaceable content component is selected if the relevance score is above a threshold).

In one embodiment, selection of the at least one replaceable content component may be performed by considering the set of replaceable content components as a whole. In one such embodiment, the comparison of the recognized content originator content with the end-user profile may result in a relevancy score indicative of the relevancy of the recognized content originator content to the end-user (e.g., the level of interest the end-user may have in receiving the recognized content originator content). In this embodiment, selection of the at least one replaceable content component may be performed according to the respective relevancy scores of the replaceable content components in the content complex (e.g., each replaceable content component having a relevancy score above a threshold is selected for modification, a threshold number of replaceable content components with the highest respective relevancy scores are selected for modification, and the like, as well as various combinations thereof).

For example, a replaceable content component conveying a car advertisement may be indexed in a manner for searching an end-user profile to determine whether the associated end-user is interested in cars. If the end-user profile indicates that the end-user is interested in cars, the replaceable content component is not selected for modification, and if the end-user profile does not indicate that the end-user is interested in cars, the replaceable content component is selected for modification (e.g., selected to be replaced with a service provider advertisement for a product with which the end-user is thought to be interested based on the end-user profile).

At step 414, at least one service provider replacement content component (denoted as replacement content component) is selected. In one embodiment, the at least replacement content component is selected using the number of replaceable content components selected for modification. In one embodiment, the at least replacement content component is selected using one or more component characteristics of each of the replaceable content components selected for modification (e.g., the size, shape, format, content type, and like characteristics, as well as various combinations thereof, of each replaceable content component selected for modification).

In one embodiment, the at least one service provider replacement content component is selected using an end-user profile associated with the end-user. In one embodiment, in which service provider replacement content associated with each service provider replacement component is indexed in a manner enabling a comparison of at least one characteristic of the service provider replacement content with the end-user profile, indexes associated with the respective service provider replacement components may be searched using information from the end-user profile. In one such embodiment, indexes associated with the respective service provider replacement components may be searched using one or more keywords from the end-user profile.

In one embodiment, the comparison of one more keywords of the end-user profile with each respective index of the service provider replacement content component may result in a relevancy score indicative of the relevancy of the service provider replacement content to the end-user (e.g., the level of interest the end-user may have in receiving the service provider replacement content). In this embodiment, selection of the at least one service provider replacement content component may be performed according to respective relevancy scores of the service provider replacement content components (e.g., a threshold number of service provider replacement content components with the highest respective relevancy scores is selected for modification).

At step 416, the selected at least one replaceable content component is modified using the selected at least one service provider replacement content component. In one embodiment, modification of a replaceable content component includes removing the replaceable content component and inserting a service provider replacement content component. In one embodiment, modification of a replaceable content component includes removing the replaceable content component and inserting white space. In one embodiment, modification of a replaceable content component includes overlaying the replaceable content component with a service provider replacement content component (e.g., such that the replaceable content component is not selectable or such that the replaceable content component is selectable).

In one embodiment, modification of replaceable content components using replaceable content components may be performed according to at least one of at least one component characteristic of each component (e.g., size, shape, content type, and the like, as well as various combinations thereof), a structure of the content complex, and the like, as well as various combinations thereof. In one embodiment, multiple replaceable content components may be modified using a single replaceable content component. In one embodiment, a single replaceable content component may be modified using multiple replaceable content components.

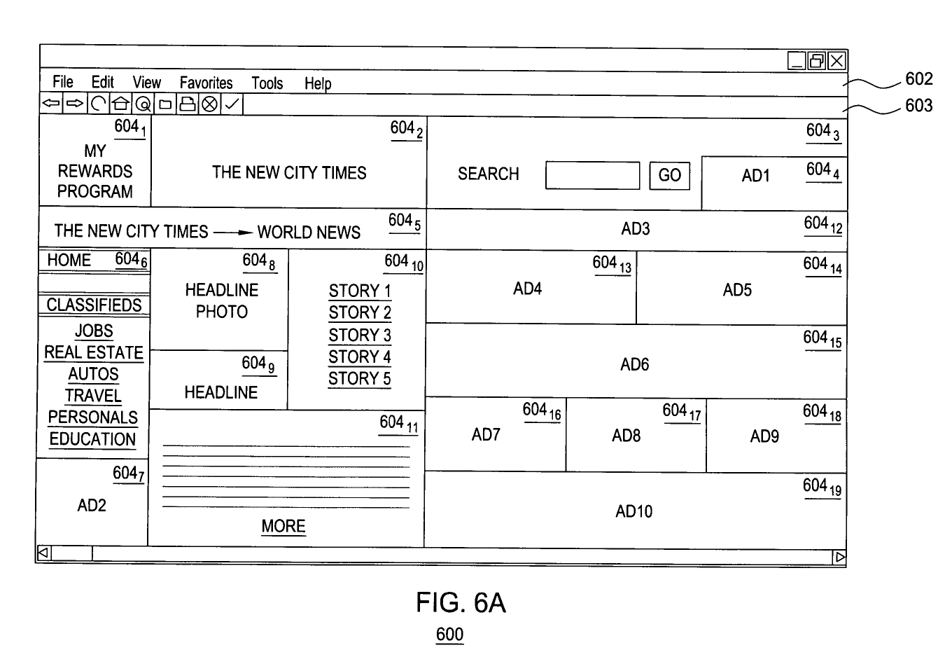

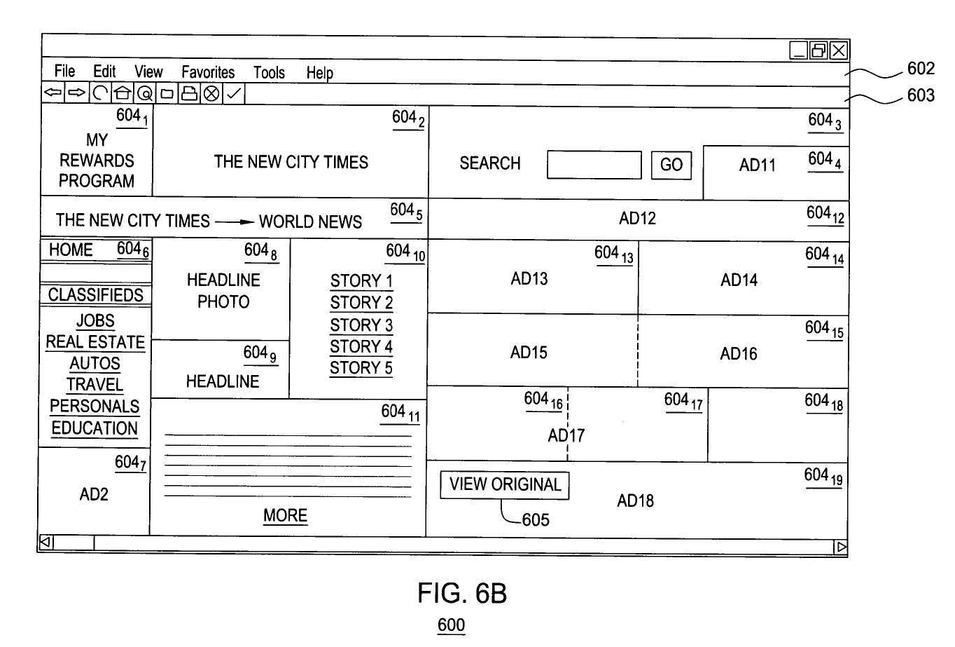

Although specific modifications are described, various other modifications of a replaceable content component may be performed using a replaceable content component. Furthermore, although modification are primarily described with respect to evaluation of the content conveyed by content components, in one embodiment, various other factors may be utilized for modifying replaceable content components using replacement content components. The modification of a replaceable content component may be performed using a replaceable content component may be better understood with respect to FIG. 6A and FIG. 6B. At step 418, method 400 ends.

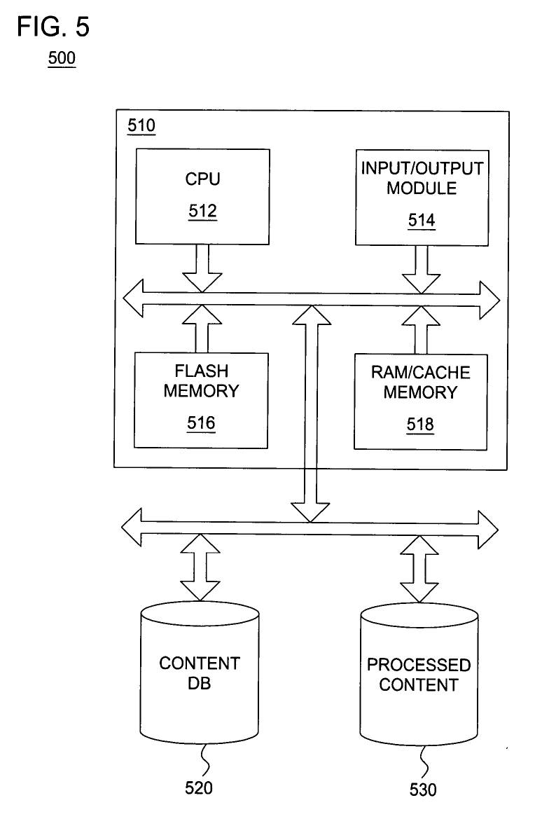

FIG. 5 depicts a high-level block diagram of a content control module. Specifically, content control module 500 of FIG. 5 includes a content control module (CCM) 510, a content database (CD) 520, and a processed content database (PCD) 530. The CCM 510 includes a central processing unit (CPU) 512, an input-output module (IOM) 514, a flash memory (FM) 516, and a random access memory (RAM) 518 (and/or cache memory). In one embodiment, FM 516 includes the content control software (e.g., for content identification, classification, analysis, recognition, modification, replacement, and performing various other content control functions depicted and described herein, as well as various combinations thereof). In one embodiment, RAM 518 may support short term memory and caching functions useful for processing in CPU 512. In one embodiment, IOM 514 may include circuit logic and associated control circuits. The various components of content control module 500 communicate using a communication bus (CB) 540. The CB 540 may be implemented using any means of enabling communication between CCM 510 and CD 520 and PCD 530, as well as between components within CCM 510.

As depicted in FIG. 5, content control module 500 is adapted for being implemented in various locations. In one embodiment, content control module 500 may be implemented as a portion of a network element within a service provider domain including content provider data centers, content provider networks, and the like (e.g., as a portion of an access router, as a portion of content server, and the like, as well as various combinations thereof). In one embodiment, content control module 500 may be implemented as a portion of a network element within an access network (e.g., as a portion of an access node). In one embodiment, content control module 500 may be implemented as a portion of an end-user device. Although described with respect to being implemented in specific locations, content control module 200 may be adapted for being implemented in various other locations.

As depicted in FIG. 5, content control module 500 supports content control for various content types including data content, audio content, video content, multimedia content, and the like, as well as various combinations thereof. The content control module 500 is adapted for providing various combinations of content control functions. In one embodiment, content control module 500 supports content control functionality including content component definition language functions, content definition functions, content recognition functions (e.g., content recognition, content type recognition, and the like, as well as various combinations thereof), content modification functions, content structuring functions, and the like, as well as various combinations thereof. The content control module 500 may be adapted to support various other content control functions (including various other content control functions described herein).

In one embodiment, content frame definition language functions may include at least one of one or more methods to define content structure (e.g., structure of a frame (e.g., video frame), structure of a webpage, and the like), one or more methods to identify critical non-replaceable components within a content complex (i.e., components which cannot be modified by the service provider), one or more methods to identify non-critical non-replaceable components within a content complex (i.e., components which cannot be modified by the service provider), one or more methods to identify non-critical replaceable components within a content complex (i.e., components which may be modified by a service provider using service provider content), and the like, as well as various combinations thereof. In one embodiment, the one or more methods to identify replaceable components within a content complex may include one or more methods to identify replaceable components which may be replaced with service provider content, masked by service provider content, skinned, and the like, as well as various combinations thereof.

In one embodiment, content definition functions may include at least one of one or more methods to define replaceable content, one or more method to capture replaceable content, one or more methods to define replacement content, and the like, as well as various combinations thereof. In one embodiment, content recognition functions may include at least one of one or more methods to identify content types (e.g., critical non-replaceable, non-critical non-replaceable, non-critical replaceable, replacement content, and the like) of content within a content complex, one or more methods to assign content importance to content within a content complex, and the like, as well as various combinations thereof.

In one embodiment, content recognition functions may include one or more methods to analyze, understand, and recognize the content conveyed within content components of a content complex. In one embodiment, content recognition functions may utilize artificial intelligence adapted for performing pattern matching and analysis, text/image/audio/video recognition, and the like, as well as various combinations thereof. In one such embodiment, for example, content recognition functions may recognize objects within image content (e.g., such as recognizing a car in an image including other imagery), recognize words or phrases within audio content (e.g., “recognizing adult language within an audio clip), recognizing objects within video frames (e.g., recognizing a soda container resting on a table in a video frame), and the like, as well as various combinations thereof.

In one embodiment, content modification functions may include at least one of one or more methods to identify replacement content, one or more methods to process replacement content, one or more methods to modify replaceable content (e.g., replace replaceable content with replacement content, superimpose replacement content over replaceable content, block/mask replaceable content with replacement content, and the like, as well as various combinations thereof), one or more methods to structure content including non-replaceable content, replaceable content, replacements content, and the like (e.g., position content, resize content, reshape content, and the like, as well as various combinations thereof), and the like, as well as various combinations thereof.

Although primarily depicted and described herein as being performed by content control module 510, in one embodiment, at least a portion of the functions of content control module 510 may be distributed across a plurality of function-specific modules. In one embodiment, for example, content structure definition language functions, content definition functions, content recognition functions, and content modification functions may be implemented as individual functional modules. In one embodiment, for example, various combinations of content structure definition language functions, content definition functions, content recognition functions, content modification functions may be implemented using one or more functional modules. Although depicted and described with respect to specific hardware and software architectures, the present invention is not intended to be limited by hardware architecture, software architecture, or any other system architecture design.

FIG. 6A and FIG. 6B depict exemplary multimedia content complexes (webpage) before and after content modification using the present invention, respectively. The exemplary content complexes of FIG. 6A and FIG. 6B are depicted and described within the context of a webpage browser 600 having a menu 602, a toolbar 603, and a plurality of webpage portions 604₁-604₁₉ (collectively, webpage portions 604). The webpage browser 600 may be any web browser operable for presenting content via a presentation device (e.g., television, monitor, and the like). The menu 602 provides selectable buttons including FILE, EDIT, VIEW, FAVORITES, TOOLS, and HELP, selection of which triggers respective drop-down menus providing various features. The webpage portions 604 are operable for presenting any content presentable using a web page (e.g., text, hyperlinks, audio, video, and the like, as well as various combinations thereof).

As depicted in FIG. 6A, webpage portion 604₁ includes an icon (illustratively, MY REWARDS PROGRAM) associated with a rewards program associated with the end-user, selection of which enables the end-user to view information associated with a rewards program by which the end-user may accumulate rewards points which may be applied toward purchases and the like. The webpage portion 604₂ includes a banner identifying the content owner (illustratively, THE NEW CITY TIMES) identifying the website of The New City Times newspaper. The webpage portion 604₃ includes a search function including a search entry field in which the end-user may enter a search word or phrase and a GO button by which the end-user may initiate the search for the entered word or phrase. The webpage portion 604₄ includes an advertisement (denoted as AD1). The webpage portion 604₅ includes a website location indicator indicating that the end-user is currently viewing the world news portion of The New City Times website (illustratively, THE NEW CITY TIMES→WORLD NEWS).

As depicted in FIG. 6A, the webpage portion 604₆ includes a hyperlink to the homepage of The New City Times website (illustratively, HOME). The webpage portion 604₆ further includes a plurality of hyperlinks to different portions of the classified ads (illustratively, JOBS, REAL ESTATE, AUTOS, TRAVEL, PERSONALS, and EDUCATION). The webpage portion 604₇ includes an advertisement (denoted as AD2). The webpage portions 604₈ and 604₉ include a photo and a headline associated with the headline news story on the World News webpage of The New City Times website, respectively. The webpage portion 604₁₀ includes a list of hyperlinks to other news stories available on the World News webpage of The New City Times website. The webpage portion 604₁₁ includes the text of at least a portion of the headline news story on the World News webpage of The New City Times website, as well as a hyperlink by which the end-user may access the remaining text of the news story (illustratively, MORE).

As depicted in FIG. 6A, the webpage portions 604₁₂-604₁₉ include content originator advertisements (denoted as AD3, AD4, AD5, AD6, AD7, AD8, AD9, and AD10, respectively), including content owner advertisements and/or content provider advertisements. Although not depicted in detail, advertisements AD1-AD10 displayed in FIG. 6A may include various types of advertisements including various types of content (e.g., hyperlinked text, logos, pictures, videos, and the like, as well as various combinations thereof, selection of which directs the end-user to the website associated with the selected advertisement). As depicted in FIG. 6A, webpage portions 604₁, 604₂, 604₃, 604₆, 604₈, 604₉, 604₁₀, and 604₁₁ include content owner non-replaceable content. As depicted in FIG. 6A, webpage portions 604₄, 604₅, 604₇, and 604₁₂-604₁₉ include content owner replaceable content (e.g., one or both of content owner content and content provider content).

As depicted in FIG. 6B, webpage portions 604₁, 604₂, 604₃, 604₆, 604₈, 604₉, 604₁₀, and 604₁₁ include content owner non-replaceable content and remain unchanged from FIG. 6A. The webpage portion 604₄ includes a service provider advertisement (denoted as AD11) (i.e., AD1 of FIG. 6A has been replaced with AD11 of FIG. 6B). The webpage portion 604₇ includes the content owner advertisement (denoted as AD2) displayed in FIG. 6A. The webpage portion 604₁₂ includes a service provider advertisement (denoted as AD12) (i.e., AD3 of FIG. 6A has been replaced with AD12 of FIG. 6B). The webpage portion 604₁₃ includes a service provider advertisement (denoted as AD13) (i.e., AD4 of FIG. 6A has been replaced with AD13 of FIG. 6B). The webpage portion 604₁₄ includes a service provider advertisement (denoted as AD14) (i.e., AD4 of FIG. 6A has been replaced with AD14 of FIG. 6B).

As depicted in FIG. 6B, the webpage portion 604₁₅ includes two service provider advertisements (denoted as AD15 and AD16) (i.e., AD6 of FIG. 6A has been replaced with AD15 and AD16 of FIG. 6B). The webpage portions 604₁₆ and 604₁₇ include a service provider advertisement (denoted as AD17) (i.e., AD7 and AD8 of FIG. 6A have been replaced with AD17 of FIG. 6B). The webpage portion 60418 is white-space) (i.e., AD9 of FIG. 6A has been removed leaving the white-space of FIG. 6B). The webpage portion 604₁₉ includes a service provider advertisement (denoted as AD18) (i.e., AD10 of FIG. 6A has been replaced with AD18 of FIG. 6B). As depicted in FIG. 6B, webpage portion 604₁₉ further includes a button 605 which, upon selection by the end-user, reveals the content originator advertisement (AD10) replaced by the service provider advertisement (AD18).

Although primarily depicted and described herein with respect to modifying webpages, the present invention may be used by service providers to modify various other forms of content. For example, in one embodiment, the present invention may be used to modify television streaming content (e.g., replacing commercials specified by a content provider with commercials specified by the service provider). For example, in one embodiment, the present invention may be used to modify television programming content (e.g., replacing defined components within television programming (e.g., strategic product placements by directors during filming of television programs)). Although described with respect to modifying specific content types, content formats, and the like, various other content types, content formats, and the like may be modified in accordance with various embodiments of the present invention.

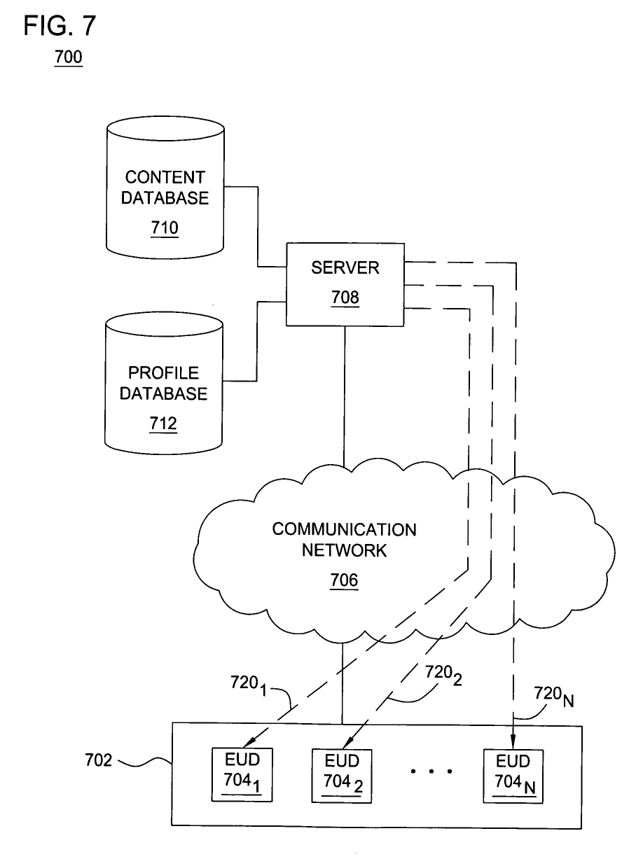

FIG. 7 depicts a high-level block diagram of a communication network for providing multiple different content versions to different end-users of an end-user group. Specifically, communication network 700 includes a group location 702 having a plurality of end-user devices (EUDs) 704₁-704_{N} (collectively, EUDs 704), a communication network (CN) 706, a server 708, a content source (CS) 710, and a profile database (PD) 712. As depicted in FIG. 7, server 708 communicates with EUDs 704 of group location 702 using CN 706. The server 708 communicates with CS 710 for retrieving original content and/or modified content available from CS 710. The server 708 communicates with PD 712 for retrieving group profiles and/or individual end-user profiles available from PD 712.

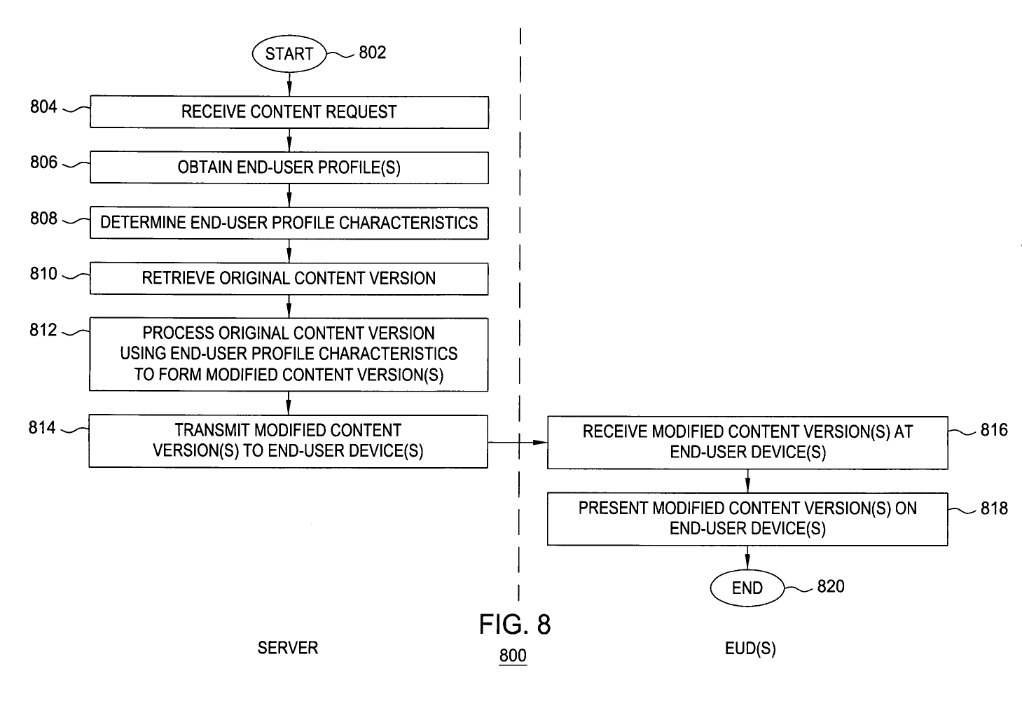

For purposes of clarity, content owner functions, content provider functions, and service provider functions are not explicitly depicted in FIG. 7. As such, in one embodiment, server 708 may be considered to include various combinations of instances of content owner servers, content provider servers, and service provider servers in cooperation to provide various functions depicted and described herein with respect to FIG. 1-FIG. 7 in a manner for satisfying end-user needs. As such, at least a portion of the functions depicted and described herein with respect to FIG. 7 and FIG. 8 may be performed using various combinations of the functions depicted and described herein with respect to FIG. 1-FIG. 7.

As depicted in FIG. 7, group location 702 is associated with an end-user group including a plurality of end-users. The group location may be any physical location such as a home location (e.g., for a family group), a business location (e.g., for a work group), and the like. Although depicted with respect to a single location, in one embodiment, members of a group may be located across multiple group locations. As depicted in FIG. 7, EUDs 704 include end-user devices associated with respective end-users of the end-user group. The EUDs 704 may include devices operable for receiving and presenting content to the respective end-users (e.g., televisions, desktop computers, laptop computers, and the like, as well as various combinations thereof).

For example, assuming group location 702 is a home housing a family, the end-user group may include a father and a mother associated with EUD 704₁ (e.g., the father and mother are watching movie on a television in their bedroom), a son associated with EUD 704₂ (e.g., the son is watching the same movie on a computer in his bedroom), and a daughter associated with EUD 704_{N} (e.g., the daughter is watching the same movie on a television in her bedroom). Since the family members are watching the same movie from different end-user devices, the present invention enables different versions of the movie to be presented to each of the family members.

As depicted in FIG. 7, in response to a determination that content is requested/scheduled to be provided to at least a portion of the end-users associated with group location 702, server 708 executes a method to modify an original content version to from a plurality of modified content versions 720₁-720_{N} (collectively, modified content versions 720) and provide the modified content versions 720₁-720_{N} to EUDs 704₁-704_{N} associated with the respective end-users of the end-user group, respectively. Although denoted as modified content versions 720, in one embodiment, at least a portion of the modified content versions 720 may include the original content version (e.g., if the end-user profile did not provide an indication that the original content version be modified to form a modified content version for that end-user). The modification of an original content version to form a plurality of modified content versions may be better understood with respect to FIG. 8.

FIG. 8 depicts a method according to one embodiment of the invention. Specifically, method 800 of FIG. 8 depicts a method for providing multiple different content versions to different end-users of an end-user group. Although primarily described with respect to television video content, those skilled in the art will appreciate that method 800 may be used to provide multiple different content versions to different end-users of an end-user group for various other content types. Although depicted as being performed serially, those skilled in the art will appreciate that at least a portion of the steps of method 800 may be performed contemporaneously, or in a different order than presented in FIG. 8. As depicted in FIG. 8, steps 804-814 are performed by a server and steps 816-818 are performed by one or more end-user devices. The method 800 begins at step 802 and proceeds to step 804.

At step 804, a content request is received. In one embodiment, in which the content request is initiated by an end-user on-demand, a content request may be received from the end-user device associated with the end-user. In one embodiment, in which the content request is initiated by a network component in response to a scheduled content request, the content request may be received from a scheduling component within the server, from another scheduling component associated with the server, and the like, as well as various combinations thereof. In one embodiment, in which a subset of the end-users in the end-user group plan are interested in receiving the content, the content request may identify the end-users interested in receiving the requested content (e.g., identifying the end-users by end-user identifier, end-user device address, and the like).

In one embodiment, a content request may include information for controlling modification of the original content version to form a modified content version. In one embodiment, such information for controlling modification of the original content version to form the modified content version may be received as a portion of the content request if the requested modification is not associated with the end-user (i.e., such that it is saved as a portion of the end-user group profile or end-user profile), but, rather, is associated with this specific request for content. In one embodiment, in which the end-user group profile and/or end-user profile stores end-user profile characteristics on a per-content basis, such information for controlling modification of the original content version to form the modified content version that is received as a portion of the content request may be stored in the end-user group profile and/or end-user profile.

For example, a content request may include a list of the end-users requesting to receive the requested content (e.g., a subset of the end-users in the end-user group). For example, a content request may include information specific to the request (e.g., although the end-user typically watches complete versions of requested movies, for this requested movie the end-user request to watch a turbo-mode version of the requested movie such that while the original movie is two hours long, the turbo mode version of the movie is condensed to be one hour long without the end-user having to use trick-play functions to control the movie (e.g., scenes or portions of scenes in the movie considered to be the least important to the plot of the movie may be deleted). Although specific examples are described, other request-specific or content-specific information may be received as a portion of content requests.

At step 806, an end-user profile(s) is obtained. At step 808, end-user profile characteristics are determined. In one embodiment, end-user profile characteristics are determined for each end-user in the end-user group interested in receiving the requested content. In one embodiment, end-user profile characteristics associated with an end-user are determined using the end-user profile associated with that end-user. In one embodiment, a server (illustratively, server 708) obtains end-user profile characteristics from an end-user profile storage component (illustratively, PD 712). The server may determine end-user profile characteristics from an end-user profile storage component either directly or indirectly.

In one embodiment, a server obtains end-user profile characteristics for each end-user directly from respective end-user profiles. In one embodiment, a server obtains end-user profile characteristics for each end-user either directly or indirectly from an end-user group profile. In one embodiment, in which an end-user group profile includes end-user profile characteristics associated with each end-user in the end-user group, the server may obtain the end-user profile characteristics from the end-user group profile. In one embodiment, in which the end-user group profile does not include end-user profile characteristics associated with each end-user in the end-user group, the server may obtain specific end-user profiles for each of the end-users in the end-user group profile. In this embodiment, the server 7 may then obtain the end-user profile characteristics from the respective end-user profiles determined from the end-user group profile.

At step 810, an original content version is retrieved. In one embodiment, the original content version may be obtained from a content source such as a content database (illustratively, CS 710), a content server, and the like, as well as various combinations thereof. At step 812, the original content version is processed to form a modified content version(s). At step 814, the modified content version(s) is transmitted to an end-user device(s). In oneAt step 816, the modified content version(s) is received at the end-user device(s). At step 818, the modified content version(s) is presented on the end-user device(s). At step 820, method 800 ends.

In one embodiment, the modified content version(s) is formed using end-user profile characteristics. In one embodiment, a modified content version may be formed using other content obtained from a content source such as a content database (illustratively, CS 710), a content server, and the like, as well as various combinations thereof. As described herein, various content types (e.g., audio, video, and the like, as well as various combinations thereof) may be modified. As described herein, modification of an original content version to form one or more modified content versions may include modifying content, modifying presentation of content, removing content, replacing content, adding content, and the like, as well as various combinations thereof.

In one embodiment, an original content version is processed to replace at least a portion of the original content with other content. In one embodiment, for example, an original content version may be processed to replace audio content within at least a portion of a scene of a movie (e.g., replacing dialog with other dialog (e.g., to eliminate profanities for a movie intended for an end-user known to be a child), replacing one song with another song by a group known to be the favorite rock group of the end-user, and the like, as well as various combinations thereof), replace video content within a scene of a movie (e.g., replace a component within a scene of a movie with another component, such as replacing a Pepsi can with a Coke can for an end-user with a known preference for Coke), replace one or more scenes of a movie with alternative scenes (e.g., to change the ending of a movie seen by a child versus the ending of that movie seen by an adult), and the like, as well as various combinations thereof.

In one embodiment, an original content version is processed to remove at least a portion of the original content. In one embodiment, for example, an original content version may be processed to remove adult content, adult language, and the like, as well as various combinations thereof, from scenes of a movie intended for an end-user known to be a child, an end-user restricted from viewing such content, and the like, as well as various combinations thereof. In one embodiment, for example, an original content version may be processed to remove one or more scenes from a movie in order to reduce the amount of time required by the end-user to watch the movie (e.g., if an end-user has one and a half hours free to watch a two hour movie, thirty minutes of the movie may be removed to enable the end-user to complete the movie during the available time).

Although primarily depicted and described herein with respect to end-users located at a single group location, in one embodiment, modified content versions may be provided to respective end-users located across multiple group locations. Although primarily described herein with respect to movie content, various other content types may be modified for providing different modified content versions of an original content version to different end-users. Although primarily described herein with respect to specific examples of content modification which may be performed using various embodiments of the present invention, the present invention is not limited by such examples (i.e., various other content modifications may be performed using the various embodiments of the present invention).

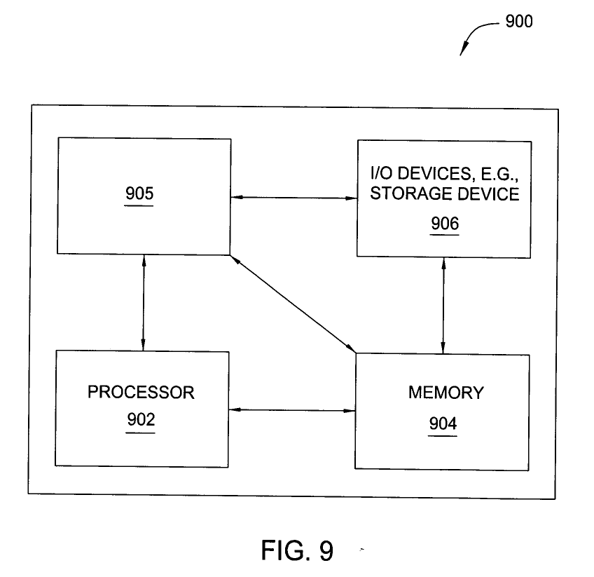

FIG. 9 depicts a high-level block diagram of a general-purpose computer suitable for use in performing the functions described herein. As depicted in FIG. 9, system 900 comprises a processor element 902 (e.g., a CPU), a memory 904, e.g., random access memory (RAM) and/or read only memory (ROM), a content control module 905, and various input/output devices 906 (e.g., storage devices, including but not limited to, a tape drive, a floppy drive, a hard disk drive or a compact disk drive, a receiver, a transmitter, a speaker, a display, an output port, and a user input device (such as a keyboard, a keypad, a mouse, and the like)).

It should be noted that the present invention may be implemented in software and/or in a combination of software and hardware, e.g., using application specific integrated circuits (ASIC), a general purpose computer or any other hardware equivalents. In one embodiment, the present content control module or process 905 can be loaded into memory 904 and executed by processor 902 to implement the functions as discussed above. As such, content control process 905 (including associated data structures) of the present invention can be stored on a computer readable medium or carrier, e.g., RAM memory, magnetic or optical drive or diskette and the like.

Although various embodiments which incorporate the teachings of the present invention have been shown and described in detail herein, those skilled in the art can readily devise many other varied embodiments that still incorporate these teachings.

What is claimed is:

1. A method for controlling content using an end-user profile associated with an end-user, comprising:
receiving, from a content originator, a content complex comprising a plurality of content originator content components conveying content originator content;
identifying each of the content originator content components classified as a replaceable content component;
analyzing the replaceable content components to recognize the content originator content conveyed by the replaceable content components; and
modifying, according to the end-user profile and the content originator content conveyed by the replaceable content components, at least one of the replaceable content components using at least one service provider replacement content component adapted for conveying service provider replacement content.

2. The method of claim 1, wherein the content originator content includes at least one of content owner content and content provider content.

3. The method of claim 1, wherein the content originator content includes content owner content and content provider content, wherein the non-replaceable content components comprise the content owner content and the replaceable content components comprise the content provider content.

4. The method of claim 3, wherein the at least one service provider content component comprises service provider revenue generating content.

5. The method of claim 1, wherein identifying each of the content originator content components classified as a replaceable content component comprises:
identifying the plurality of content originator content components within the content complex;
determining a content component type associated with each of the content originator content components; and
classifying the content originator content components according to the content component types of the content originator content components.

6. The method of claim 1, wherein analyzing each replaceable content component comprises:
processing the replaceable content component to identify at least one content characteristic of the content originator content conveyed by the replaceable content component; and
recognizing the content originator content conveyed by the replaceable content component according to the at least one content characteristic.

7. The method of claim 1, wherein modifying at least a portion of the replaceable content components comprises:
selecting, using the end-user profile and the content originator content conveyed by the replaceable content components, the at least one replaceable content component;
selecting, using the end-user profile, the at least one service provider replacement content component from a plurality of service provider replacement content components; and
modifying the selected at least one replaceable content component using the selected at least one service provider replacement content component.

8. The method of claim 7, wherein selecting the at least one replaceable content component comprises:
parsing each of the replaceable content components to identify at least one content characteristic of the content originator content conveyed by each of the replaceable content components;
comparing, for each of the replaceable content components, the at least one content characteristic associated with the replaceable content component with the end-user profile; and
selecting the at least one replaceable content component according to the comparisons of the respective content characteristics with the end-user profile.

9. The method of claim 7, wherein selecting the at least one service provider replacement content component comprises:
identifying at least one end-user characteristic associated with the end-user profile; and
selecting the at least one service provider replacement content component by searching each of a plurality of indexes associated with the respective plurality of service provider replacement content components using the at least one end-user characteristic.

10. The method of claim 1, wherein modifying the at least one replaceable content component comprises:
determining at least one complex characteristic associated with the content complex;
determining at least one component characteristic associated with each of the at least one replaceable content component and each of the at least one service provider replacement content component; and
modifying the at least one replaceable content component using the at least one service provider replacement content component according to the at least one complex characteristic and the at least one component characteristic associated with each of the at least one replaceable content component and each of the at least one service provider replacement content component.

11. The method of claim 1, wherein modifying each of the at least one replaceable content component comprises one of:
replacing the replaceable content component with the service provider replacement content component; or
overlaying the replaceable content component with the service provider replacement content component.

12. The method of claim 1, wherein the content originator content is formed by a method comprising:
receiving a request for content from an end-user device associated with the end-user;
retrieving the non-replaceable content components using the request for content;
retrieving the replaceable content components according to at least one of the request for content, the content originator content conveyed by the non-replaceable content components, or another end-user profile associated with the end-user; and
structuring the non-replaceable content components and replaceable content components to form thereby the content complex.

13. The method of claim 1, further comprising:
structuring the non-replaceable content components and the at least one service provider replacement content component to form thereby a modified content complex; and
transmitting the modified content complex toward an end-user device associated with the end-user.

14. The method of claim 13, further comprising:
receiving the modified content complex at the end-user device; and
processing the modified content complex to present, using a presentation interface of the end-user device, the content originator content conveyed by the replaceable content components and the service provider replacement content conveyed by the at least one service provider replacement content component.

15. An apparatus for controlling content using an end-user profile associated with an end-user, comprising:
means for receiving, from a content originator, a content complex comprising a plurality of content originator content components conveying content originator content;
means for identifying each of the content originator content components classified as a replaceable content component;
means for analyzing the replaceable content components to recognize the content originator content conveyed by the replaceable content components; and
means for modifying, according to the end-user profile and the content originator content conveyed by the replaceable content components, at least one of the replaceable content components using at least one service provider replacement content component adapted for conveying service provider replacement content.

16. The apparatus of claim 15, wherein the means for identifying each of the content originator content components classified as a replaceable content component comprises:
means for identifying the plurality of content originator content components within the content complex;
means for determining a content component type associated with each of the content originator content components; and
means for classifying the content originator content components according to the content component types of the content originator content components.

17. The apparatus of claim 15, wherein the means for analyzing each replaceable content component comprises:
means for processing the replaceable content component to identify at least one content characteristic of the content originator content conveyed by the replaceable content component; and
means for recognizing the content originator content conveyed by the replaceable content component according to the at least one content characteristic.

18. The apparatus of claim 15, wherein the means for modifying at least a portion of the replaceable content components comprises:
means for selecting, using the end-user profile and the content originator content conveyed by the replaceable content components, the at least one replaceable content component;
means for selecting, using the end-user profile, the at least one service provider replacement content component from a plurality of service provider replacement content components; and
means for modifying the selected at least one replaceable content component using the selected at least one service provider replacement content component.

19. The apparatus of claim 18, wherein the means for selecting the at least one replaceable content component comprises:
means for parsing each of the replaceable content components to identify at least one content characteristic of the content originator content conveyed by each of the replaceable content components;
means for comparing, for each of the replaceable content components, the at least one content characteristic associated with the replaceable content component with the end-user profile; and
means for selecting the at least one replaceable content component according to the comparisons of the respective content characteristics with the end-user profile.

20. The apparatus of claim 18, wherein the means for selecting the at least one service provider replacement content component comprises:
means for identifying at least one end-user characteristic associated with the end-user profile; and
means for selecting the at least one service provider replacement content component by searching each of a plurality of indexes associated with the respective plurality of service provider replacement content components using the at least one end-user characteristic.

21. The apparatus of claim 15, wherein modifying each of the at least one replaceable content component comprises one of:
replacing the replaceable content component with the service provider replacement content component; or
overlaying the replaceable content component with the service provider replacement content component.

22. The apparatus of claim 15, wherein the content originator content is formed by:
means for receiving a request for content from an end-user device associated with the end-user;
means for retrieving the non-replaceable content components using the request for content;
means for retrieving the replaceable content components according to at least one of the request for content, the content originator content conveyed by the non-replaceable content components, or another end-user profile associated with the end-user; and
means for structuring the non-replaceable content components and replaceable content components to form thereby the content complex.

23. A method, comprising:
receiving, at an end-user device, a modified content complex formed by a method comprising:
receiving, from a content originator, a content complex comprising a plurality of content originator content components conveying content originator content;
identifying each of the content originator content components classified as a replaceable content component;
analyzing the replaceable content components to recognize the content originator content conveyed by the replaceable content components; and
modifying, according to the end-user profile and the content originator content conveyed by the replaceable content components, at least one of the replaceable content components using at least one service provider replacement content component adapted for conveying service provider replacement content.

24. An apparatus, comprising:
an end-user device for receiving a modified content complex formed by:
means for receiving, from a content originator, a content complex comprising a plurality of content originator content components conveying content originator content;
means for identifying each of the content originator content components classified as a replaceable content component;
means for analyzing the replaceable content components to recognize the content originator content conveyed by the replaceable content components; and
means for modifying, according to the end-user profile and the content originator content conveyed by the replaceable content components, at least one of the replaceable content components using at least one service provider replacement content component adapted for conveying service provider replacement content.

25. A method, comprising:
obtaining a plurality of end-user profiles associated with a respective plurality of end-users forming an end-user group in response to a request for content received from one of the end-users;
processing an original version of the requested content to form thereby a plurality of modified versions of the requested content associated with respective end-users, wherein each modified version of the requested content is formed using at least one end-user profile characteristic associated with the end-user; and
transmitting the modified versions of the requested content toward a plurality of end-user devices associated with the respective end-users of the end-user group.

26. An apparatus, comprising:
means for obtaining a plurality of end-user profiles associated with a respective plurality of end-users forming an end-user group in response to a request for content received from one of the end-users;
means for processing an original version of the requested content to form thereby a plurality of modified versions of the requested content associated with respective end-users, wherein each modified version of the requested content is formed using at least one end-user profile characteristic associated with the end-user; and
means for transmitting the modified versions of the requested content toward a plurality of end-user devices associated with the respective end-users of the end-user group.
